(19) United States
(12) Patent Application Publication
(10) Pub. No.: US 2024/0374947 A1
(43) Pub. Date: Nov. 14, 2024

(54) SYSTEM AND METHOD FOR CONTAMINANT AND CARCINOGEN FREE FIREFIGHTER TRAINING

(71) Applicant: Peter Kirvin, Venice, FL (US)

(72) Inventor: Peter Kirvin, Venice, FL (US)

(21) Appl. No.: 18/195,008

(22) Filed: May 9, 2023

(51) Int. Cl. A62C 99/00; G09B 9/00

(52) U.S. Cl. CPC A62C 99/0081; G09B 9/00

(57) ABSTRACT

A safety system for clean, contaminant, and carcinogen free firefighter training may use compressed air and water vapor to provide a safe yet realistic firefighting mock scenario.

### TECHNICAL FIELD

The embodiments generally relate to the field of training systems and methods.

### BACKGROUND

Safety systems and current training facilities for firefighter training are dangerous to firefighter health and safety. Traditional fire training facilities and props burn wood or hay to create smoke to provide realistic fire conditions such as low visibility, thermal layering, and heat. These methods have proved to cause an increase in firefighters developing cancer. The other option is propane props which provide fire and heat but do not replicate the realistic smoke conditions. A need exists for systems and methods of training firefighters which provide low visibility, thermal layering, and heat while minimizing or eliminating contaminants and carcinogens.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, a system or method may include a fixed or mobile environment for training firefighters including at least one steam generator or water vapor generator and system for distributing steam or water vapor within the environment. The system may provide for heat, thermal layering, ventilation, obstructed trainee vision, fire attack, backdraft, flashover, flameover, and rollover.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates an illustrative depiction of a system and method for contaminant and carcinogen free firefighter training according to some embodiments; and

FIG. 2 illustrates an illustrative, simplified depiction of a system and method for contaminant and carcinogen free firefighter training according to some embodiments.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system or methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to system or method for providing a safe fixed or mobile safe environment firefighter training facility designed to provide practical training experience repeatedly in a clean, carcinogen free environment.

The system and method may include steam generators to provide both keep within the environment as well as water vapor or steam to replicate the visual appearance of smoke. In this way, the system may provide the appearance of thermal layering and obstructed vision just as smoke would in a real-life scenario.

The system and method may provide a means for simulating fire, rollover, flashover, backdraft, and the like via the use of lighting, internal props, and compressed air.

The system and method may provide a means for firefighter training with lower operational costs and lower maintenance than traditional burn rooms or flashover trailers used in the field.

The system and method may include a fixed or mobile room or environment including a darkly colored waterproof interior in fluid communication with at least one steam generation turn to provide different fire and heat conditions throughout the training scenario. Additional compressed air generators including inlets and outlets may provide replication of backdraft or flashover scenarios. Various lighting, props, or digital displays may be utilized to create the appearance and effect of live fire. In this way, the system may provide a clean environment and scenario to reduce likelihood of trainee firefighter injury or illness also providing a safe, low maintenance, controlled experience.

The system and method may be used in conjunction with propane props, fire sprinkler props, forcible entry props, and the like. The system and method may reduce operational and training costs by reducing dependence on gas, wood, hay, burn room heat panels, burn barrels, torches, or the like.

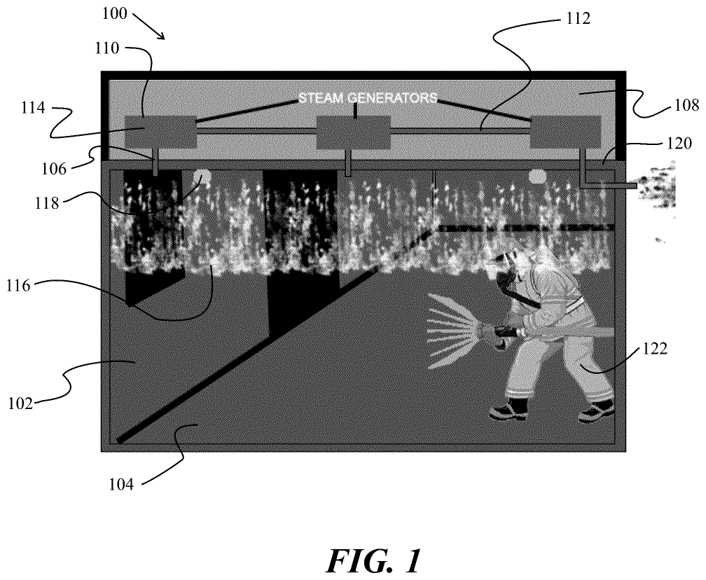

Referring to FIG. 1, a system and method 100 for contaminant and carcinogen free firefighter training may include a stationary or mobile environment 102 including at least one room or scenario 104 including at least one overhead structure 108 disposed over the room or scenario 104 via upper rig 120. According to some embodiments, the stationary or mobile environment 102 may include multiple rooms, doors, windows, and the like to simulate realistic structures for the purposes of training. A clean fire system 110 may be disposed within the overhead structure 108 or within the environment 102. The clean fire system 110 may include at least one steam generator 114 and flow structure 112 defining a conduit constructed and arranged to flow steam or water vapor 116 between steam generators 114 or into the environment 102 via outlets 106. The system and method 100 may include lighting fixtures 118 to enhance the simulation of a live fire exercise. Trainees 122 may use the system and method to conduct exercises or drills including heat, thermal layering, ventilation, obstructed vision, fire attack, backdraft, flashover, flameover, and rollover.

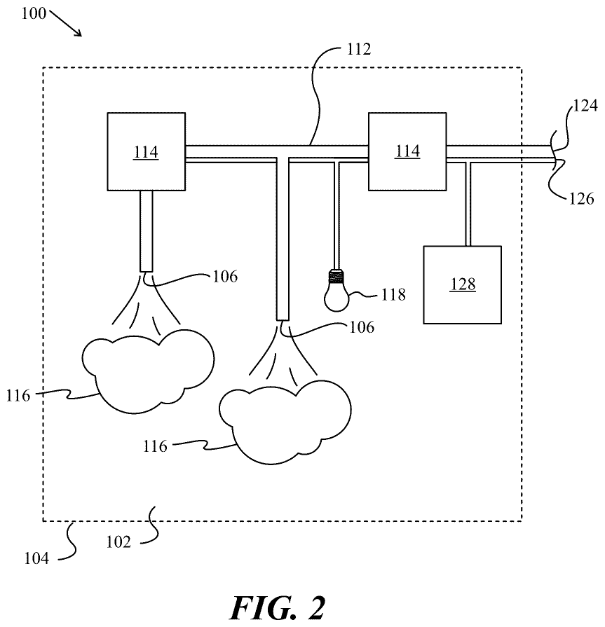

Referring to FIG. 2, a system and method 100 for contaminant and carcinogen free firefighter training may include a training scenario 104. A clean fire system 110 may be implemented within the training scenario 104. The clean fire system 110 may include at least one steam generator 114 and flow structure 112 constructed and arranged to flow steam or water vapor 116 between steam generators 114 or into the environment 102 via outlets 106. The flow structure 112 may include a plurality of pipes constructed and arranged to communicate the flow of fluid, liquid, or gas from a source 124, such as a water source. Electrical infrastructure 126 may provide electrical power to steam generators 114 or lighting fixtures 118. The system and method 100 may include lighting fixtures 118 to enhance the simulation of a live fire exercise. Trainees 122 may use the system and method to conduct exercises or drills including heat, thermal layering, ventilation, obstructed vision, fire attack, backdraft, flashover, flameover, and rollover.

As a non-limiting example, the system or method 100 may emit steam or water vapor 116 via the steam generators 114 fed by source 124 while simultaneously flashing, pulsing, or providing steady light from lightings fixtures 118 to simulate a life-fire training exercise. Display device 128 may be in operable communication with the electrical infrastructure 126 to provide live or prerecorded video during the scenario, such as video or fire or flames, or persons in need of rescue, or for communicated information to a trainee within the scenario 104.

According to one embodiment, the system may be in operable communication with a computer device in operable communication with the electrical infrastructure, flow structure, lights, displays, and the like. The system may be constructed and arranged to control the flow of steam, use of lights and displays, and the like. According to some embodiments, the system is operable via smart device, such as a smartphone or control panel, and accompanying software.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a system for contaminant and carcinogen free firefighter training, may include a clean fire system including: at least one water vapor generator; at least one flow structure including at least one outlet and defining at least one conduit; at least one lighting fixture; the clean fire system being constructed and arranged to generate and flow water vapor from the at least one water vapor generator, through the at least one flow structure, and into an environment; and wherein the system for contaminant and carcinogen free firefighter training is constructed and arranged to simulate at least one of heat, thermal layering, ventilation, obstructed vision, fire attack, backdraft, flashover, flameover, or rollover.

Variation 2 may include system for contaminant and carcinogen free firefighter training as in variation 1, wherein the at least one water vapor generator includes a steam generator.

Variation 3 may include system for contaminant and carcinogen free firefighter training as in any of variations 1 or 2, wherein the at least one water vapor generator includes a plurality of steam generators.

Variation 4 may include system for contaminant and carcinogen free firefighter training as in any of variations 1 through 3, wherein the at least one water vapor generator includes an ultrasonic vaporizer.

Variation 5 may include system for contaminant and carcinogen free firefighter training as in any of variations 1 through 4, wherein the at least one lighting fixture includes a plurality of lighting fixtures.

Variation 6 may include system for contaminant and carcinogen free firefighter training as in any of variations 1 through 5, wherein the flow structure is constructed and arranged to flow a first fluid to the at least one steam generator, and to flow a second fluid from the at least one steam generator to the environment.

Variation 7 may include system for contaminant and carcinogen free firefighter training as in any of variations 1 through 6, further including an electrical infrastructure in operable communication with the at least one steam generator and the at least one lighting fixture.

Variation 8 may include system for contaminant and carcinogen free firefighter training as in any of variations 1 through 7, wherein the system for contaminant and carcinogen free firefighter training further includes at least one structure at least partially enclosing the environment.

Variation 9 may include system for contaminant and carcinogen free firefighter training as in any of variations 1 through 8, wherein the at least one structure is a mobile structure.

According to variation 10, a system for contaminant and carcinogen free firefighter training, may include at least one steam generator constructed and arranged to generate steam; a flow structure including at least one outlet and defining a conduit, the at least one outlet being in fluid communication with the at least one steam generator via the conduit; an electrical infrastructure in operable communication with at least one steam generator; at least one lighting fixture in operable communication with the electrical infrastructure; and wherein the system for contaminant and carcinogen free firefighter training is constructed and arranged to simulate at least one of heat, thermal layering, ventilation, obstructed vision, fire attack, backdraft, flashover, flameover, or rollover.

Variation 11 may include system for contaminant and carcinogen free firefighter training as in variation 10, further including at least one valve in fluid communication with the at least one steam generator, the conduit, and the at least one outlet.

Variation 12 may include system for contaminant and carcinogen free firefighter training as in any of variations 10 or 11, further including at least one computing device in operable communication with the system for contaminant and carcinogen free firefighter training.

Variation 13 may include system for contaminant and carcinogen free firefighter training as in any of variations 10 through 12, wherein the at least one computing device is configured to control dispersal of steam from the at least one steam generator.

Variation 14 may include system for contaminant and carcinogen free firefighter training as in any of variations 10 through 13, wherein the at least one computing device is configured to control at least one of the at least one steam generator, the at least one valve, the electrical infrastructure, or the at least one lighting fixture.

According to variation 15, a method for contaminant and carcinogen free firefighter training, may include simulating at least one of heat, thermal layering, ventilation, obstructed vision, fire attack, backdraft, flashover, flameover, or rollover, including dispersing water vapor within at least a portion of an environment within a structure; and illuminating at least a portion of the environment.

Variation 16 may include a method for contaminant and carcinogen free firefighter training as in variation 15, wherein the structure is an at least partially enclosed structure.

Variation 17 may include a method for contaminant and carcinogen free firefighter training as in any of variations 15 or 16, wherein the structure is a mobile structure.

Variation 18 may include a method for contaminant and carcinogen free firefighter training as in any of variations 15 through 17, wherein dispersing water vapor within at least a portion of the environment within the structure including dispersing steam via at least one steam generator within at least a portion of the environment.

Variation 19 may include a method for contaminant and carcinogen free firefighter training as in any of variations 15 through 18, wherein dispersing water vapor within at least a portion of the environment within the structure including dispersing water vapor via ultrasonic vaporizer within at least a portion of the environment.

Variation 20 may include a method for contaminant and carcinogen free firefighter training as in any of variations 15 through 19, may further include providing a clean fire system including at least one steam generator; at least one flow structure including at least one outlet and defining at least one conduit; at least one lighting fixture; the clean fire system being constructed and arranged to generate and flow steam from the at least one steam generator, through the at least one flow structure, and into an environment; and wherein the system for contaminant and carcinogen free firefighter training is constructed and arranged to simulate at least one of heat, thermal layering, ventilation, obstructed vision, fire attack, backdraft, flashover, flameover, or rollover.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

I/We claim:

1. A system for contaminant and carcinogen free firefighter training, comprising:
a clean fire system comprising:
at least one water vapor generator;
at least one flow structure comprising at least one outlet and defining at least one conduit;
at least one lighting fixture;
the clean fire system being constructed and arranged to generate and flow water vapor from the at least one water vapor generator, through the at least one flow structure, and into an environment; and
wherein the system for contaminant and carcinogen free firefighter training is constructed and arranged to simulate at least one of heat, thermal layering, ventilation, obstructed vision, fire attack, backdraft, flashover, flameover, or rollover.

2. A system for contaminant and carcinogen free firefighter training as in claim 1, wherein the at least one water vapor generator comprises a steam generator.

3. A system for contaminant and carcinogen free firefighter training as in claim 1, wherein the at least one water vapor generator comprises a plurality of steam generators.

4. A system for contaminant and carcinogen free firefighter training as in claim 1, wherein the at least one water vapor generator comprises an ultrasonic vaporizer.

5. A system for contaminant and carcinogen free firefighter training as in claim 1, wherein the at least one lighting fixture comprises a plurality of lighting fixtures.

6. A system for contaminant and carcinogen free firefighter training as in claim 1, wherein the flow structure is constructed and arranged to channel a first fluid to the at least one water vapor generator, and to channel a second fluid from the at least one steam generator to the environment.

7. A system for contaminant and carcinogen free firefighter training as in claim 1, further comprising an electrical infrastructure in operable communication with the at least one water vapor generator and the at least one lighting fixture.

8. A system for contaminant and carcinogen free firefighter training as in claim 1, wherein the system for contaminant and carcinogen free firefighter training further comprises at least one structure at least partially enclosing the environment.

9. A system for contaminant and carcinogen free firefighter training as in claim 8, wherein the at least one structure is a mobile structure.

10. A system for contaminant and carcinogen free firefighter training, comprising:
at least one steam generator constructed and arranged to generate steam;
a flow structure comprising at least one outlet and defining a conduit, the at least one outlet being in fluid communication with the at least one steam generator via the conduit;
an electrical infrastructure in operable communication with at least one steam generator;
at least one lighting fixture in operable communication with the electrical infrastructure; and
wherein the system for contaminant and carcinogen free firefighter training is constructed and arranged to simulate at least one of heat, thermal layering, ventilation, obstructed vision, fire attack, backdraft, flashover, flameover, or rollover.

11. A system for contaminant and carcinogen free firefighter training as in claim 10, further comprising at least one valve in fluid communication with the at least one steam generator, the conduit, and the at least one outlet.

12. A system for contaminant and carcinogen free firefighter training as in claim 11, further comprising at least one computing device in operable communication with the system for contaminant and carcinogen free firefighter training.

13. A system for contaminant and carcinogen free firefighter training as in claim 12, wherein the at least one computing device controls dispersal of steam from the at least one steam generator.

14. A system for contaminant and carcinogen free firefighter training as in claim 13, wherein the at least one computing device controls at least one of the at least one steam generator, the at least one valve, the electrical infrastructure, or the at least one lighting fixture.

15. A method for contaminant and carcinogen free firefighter training, comprising:
simulating at least one of heat, thermal layering, ventilation, obstructed vision, fire attack, backdraft, flashover, flameover, or rollover, comprising:
dispersing water vapor within at least a portion of an environment within a structure; and
illuminating at least a portion of the environment.

16. A method for contaminant and carcinogen free firefighter training as in claim 15, wherein the structure is an at least partially enclosed structure.

17. A method for contaminant and carcinogen free firefighter training as in claim 15, wherein the structure is a mobile structure.

18. A method for contaminant and carcinogen free firefighter training as in claim 15, wherein dispersing water vapor within at least a portion of the environment within the structure comprising dispersing steam via at least one steam generator within at least a portion of the environment.

19. A method for contaminant and carcinogen free firefighter training as in claim 15, wherein dispersing water vapor within at least a portion of the environment within the structure comprising dispersing water vapor via ultrasonic vaporizer within at least a portion of the environment.

20. A method for contaminant and carcinogen free firefighter training as in claim 15, further comprising providing a clean fire system comprising:
at least one steam generator,
at least one flow structure comprising at least one outlet and defining at least one conduit;
at least one lighting fixture; and
the clean fire system being constructed and arranged to generate and channel steam from the at least one steam generator, through the at least one flow structure, and into an environment.
